(19) United States
(12) Patent Application Publication
(10) Pub. No.: US 2011/0158308 A1
(43) Pub. Date: Jun. 30, 2011

(54) EMBEDDED TRANSMISSION OF MULTIPLE SERVICES IN A DIGITAL TERRESTRIAL TELEVISION MULTIMEDIA BROADCASTING (DTMB) SYSTEM

(75) Inventors: Shigang Tang, Hong Kong (HK); Yangang Li, Hong Kong (HK); Jun Wang, Beijing (CN); Xiaoqing Wang, Beijing (CN); Jian Song, Beijing (CN)

(73) Assignee: Hong Kong Applied Science and Technology Research Institute Company Limited, Shatin (HK)

(21) Appl. No.: 12/647,279

(22) Filed: Dec. 24, 2009

(51) Int. Cl. H04N 11/04; H04L 27/00; H04B 7/00

(52) U.S. Cl. 375/240.01; 375/316; 370/310; 375/E07.026

(57) ABSTRACT

A system and method is described for transmitting and receiving terrestrial and mobile services in one spectrum in a Digital Terrestrial Television Multimedia Broadcasting (DTMB) terrestrial network compatible with conventional terrestrial receivers. Terrestrial service data and mobile service data to be broadcast are provided. The packet headers for the mobile service data are scrambled and the terrestrial service data is scrambled. The terrestrial service data and mobile service data is multiplexed together to form multiplexed terrestrial service data and mobile service data. The multiplexed terrestrial service data and mobile service data is received at a terrestrial DTMB receiver which distinguishes the terrestrial service data from the mobile service data on the basis of packet headers. At a mobile DTMB receiver, the multiplexed terrestrial service data and mobile service data is received and control frames are used to distinguish the terrestrial service data from the mobile service data.

### BACKGROUND OF THE INVENTION

1. Field of the Invention

The present invention relates to Digital Terrestrial Television Multimedia Broadcasting systems (DTMB systems) and, more particularly, to DTMB systems that can transmit both terrestrial and mobile services in one spectrum while being compatible with existing terrestrial receivers.

2. Description of Related Art

Digital Terrestrial Television Multimedia Broadcasting systems (DTMB systems) are systems which conform to the China standard on digital terrestrial broadcasting, GB20600-2006, the disclosure of which is incorporated by reference herein. The modulation scheme used is TDS-OFDM (Time Domain Synchronous Orthogonal Frequency Division Multiplexed). The signal structure includes a signal frame. A frame includes a frame header and a frame body; a superframe is a number of frames equaling 125 ms, a minute frame is 1s, and a day frame is 24 hours. The frame header uses a pseudo-random noise (PN) sequence instead of a cyclic prefix (CP). This conventional frame structure is depicted in FIG. 7. Further details of DTMB systems are described in Song et al., “Technical Review on Chinese Digital Terrestrial Television Broadcasting Standard and Measurement on Some Working Modes,” IEEE Transactions on Broadcasting, Vol. 53, No. 1, March 2007, pp. 1-7 the disclosure of which is incorporated by reference herein, and Zhang et al., “An Introduction of the Chinese DT′TB Standard Analysis of the PN595 Working Modes,” IEEE Transactions on Broadcasting, Vol. 53, No. 1, March 2007, pp. 8-13, the disclosure of which is incorporated by reference herein. DTMB systems are capable of transmission to both terrestrial and mobile devices. With the proliferation of mobile devices such as mobile phones, PDAs, notebook computers, e-books, etc., there is an increasing demand for mobile-specific services beyond the receipt of terrestrial broadcast television. Because DTMB systems are capable of transmitting to mobile devices, it would be convenient to be able to transmit mobile-specific services over the same spectrum as the terrestrial signal.

In the ETSI EN 300 744DVB-T standard, terrestrial services are multiplexed with mobile services into one transport stream before being processed by a conventional digital terrestrial transmitter. However, this technique is not compatible with existing DTMB receivers.

In U.S. Patent Application Publication 2008/0025195, at least two programs having different modulation are transmitted in one spectrum in an orthogonal frequency division multiplexed (OFDM) system. In this system the at least two programs share a control frame. Both the terrestrial and the mobile devices must read the control frame to determine whether the content is terrestrial data or mobile data. However, existing DTMB receivers are not compatible with this control frame checking.

Thus there is a need in the art for improved methods and apparatus for transmitting mobile data services and terrestrial data services in the same spectrum while being compatible with existing DTMB receivers.

### SUMMARY OF THE INVENTION

The present invention relates to a system and method for transmitting and receiving terrestrial and mobile services in one spectrum in a Digital Terrestrial Television Multimedia Broadcasting (DTMB) terrestrial network which is compatible with conventional terrestrial receivers. Terrestrial service data and mobile service data to be broadcast are provided. The packet headers for the mobile service data are scrambled and the terrestrial service data is scrambled. The terrestrial service data and mobile service data is multiplexed together to form multiplexed terrestrial service data and mobile service data. The multiplexed terrestrial service data and mobile service data is received at a terrestrial DTMB receiver which distinguishes the terrestrial service data from the mobile service data on the basis of packet headers. At a mobile DTMB receiver, the multiplexed terrestrial service data and mobile service data is received and control frames are used to distinguish the terrestrial service data from the mobile service data.

### BRIEF DESCRIPTION OF THE DRAWINGS

FIG. 1 schematically depicts a transmitter for transmitting multiplexed terrestrial service data and mobile service data over the same spectrum in a DTMB system.

FIG. 2 demonstrates an example of extension mapping.

FIG. 3 demonstrates another example of extension mapping.

FIG. 4 depicts format matching for the data of FIG. 2.

FIG. 5 depicts format matching for the data of FIG. 3.

FIG. 6 schematically depicts a mobile DTMB receiver according to one aspect of the present invention.

FIG. 7 depicts the conventional frame structure for DTMB systems.

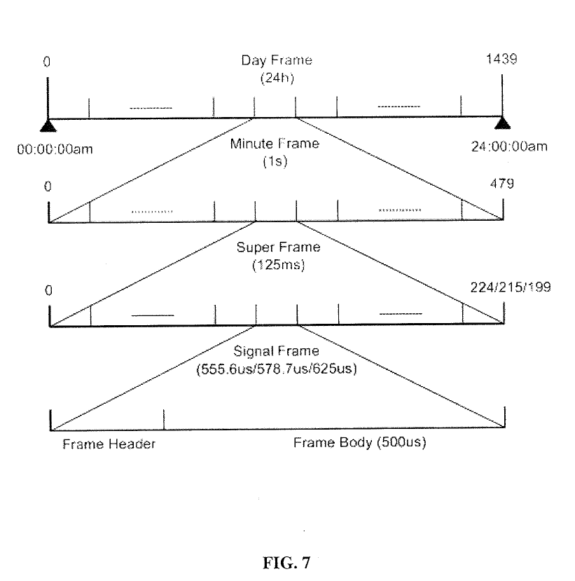

### DETAILED DESCRIPTION

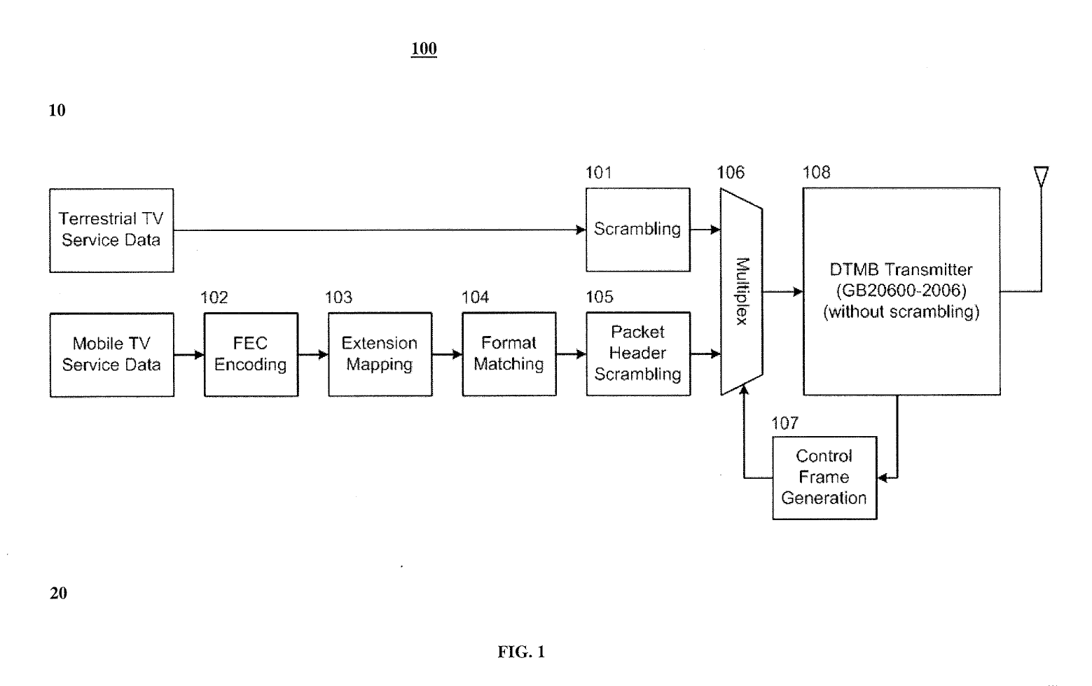

Turning to the drawings in detail, FIG. 1 schematically depicts a transmitter 100 according to one embodiment of the present invention. Transmitter 100 multiplexes both terrestrial service data and mobile service data for reception by both terrestrial and mobile receivers in a DTMB system. The terrestrial service data 10 can include video, for example, in MPEG-2 format (although other formats such as H.264, MPEG-4, etc, may also be used), audio, and/or data; such data can be, for example, a broadcast television program that includes video and audio. Examples of terrestrial service data are well-known in the art and the transmitter of the present invention is configured to carry these various types of data as set forth in the GB20600-2006 standard. Note that data 10 can itself be a multiplexed stream of data, e.g., various programs for television channels multiplexed together in a single terrestrial data stream.

Similarly mobile service data 20 can include video, audio, and/or data which can be multiplexed together as a single data stream (not shown) as is well-known in the art. Note however that all transmissions made under the DTMB standard can be received by mobile devices as well as terrestrial devices. Thus, in the following description, “mobile service data” refers to data/applications that are only for mobile devices while “terrestrial service data” refers to data that can be decoded by either a terrestrial device or a mobile device.

Prior to transmission, terrestrial service data is scrambled in scrambler 101; this scrambling is specified in the standard and terrestrial service data is descrambled by the existing terrestrial receivers.

Prior to transmission, mobile data 20 is subjected to Forward Error Correction (FEC) encoding in module 102; FEC is well-known in the art and will not be further described here. Low density parity check (LDPC) can be used for forward error correction; however, other codes may be selected depending upon the coding rate, the error correction capability, the complexity of encoding and decoding, and the transmission environment.

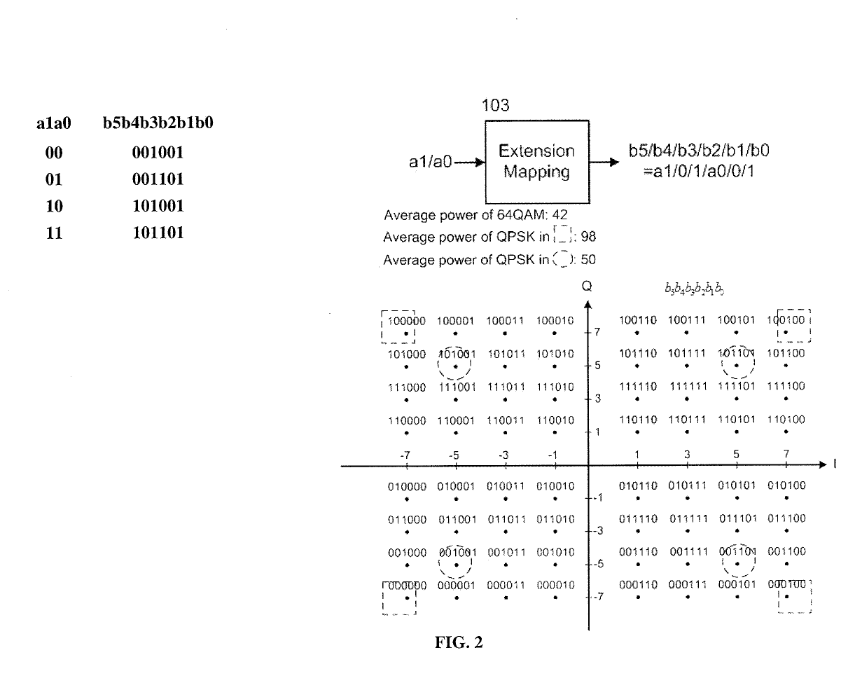

The FEC-encoded mobile service data undergoes extension mapping in module 103. In this module, for example, a low-order quadrature amplitude modulated (QAM) signal is embedded within a high-order QAM signal. Low-order QAM such as quadrature phase shift key (QPSK) provides better reception in a mobile environment; high-order QAM such as 64QAM with a 0.6 coding rate provides high data throughput and is useful for HDTV and SDTV programs. In one example, depicted in FIG. 2, the terrestrial service data signal is 64 QAM and the mobile service data signal is a QPSK signal, the QPSK signal undergoes 2 bit to 6 bit mapping in extension mapping module 103. As seen in FIG. 2, the points that are selected involve a tradeoff between reception and transmitter power performance. For FIG. 2, the average power of 64QAM is 42. If the four “squared points” at the corner of the 64QAM constellation are selected, the average power is 98. Alternatively, if the four “circled points” at the inner corner of the 64QAM constellation are selected, the average power is 50. Although, both the sets of points can be used, since the average power of the four “circled points” is closer to that of the 64QAM, choosing these four points (circled points) will have minimal impact on the terrestrial service data.

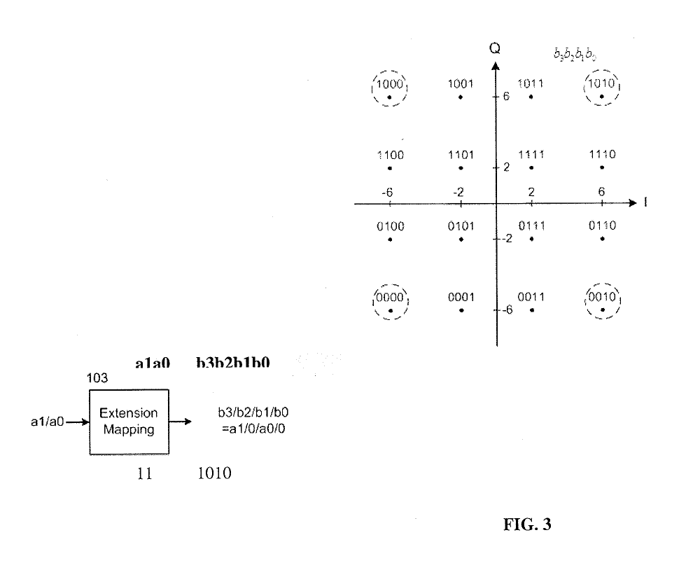

In another example depicted in FIG. 3, if the terrestrial service data signal is a 16 QAM signal, and the mobile service data signal is a QPSK signal, the QPSK signal undergoes 2 to 4 bit mapping in extension mapping module 103.

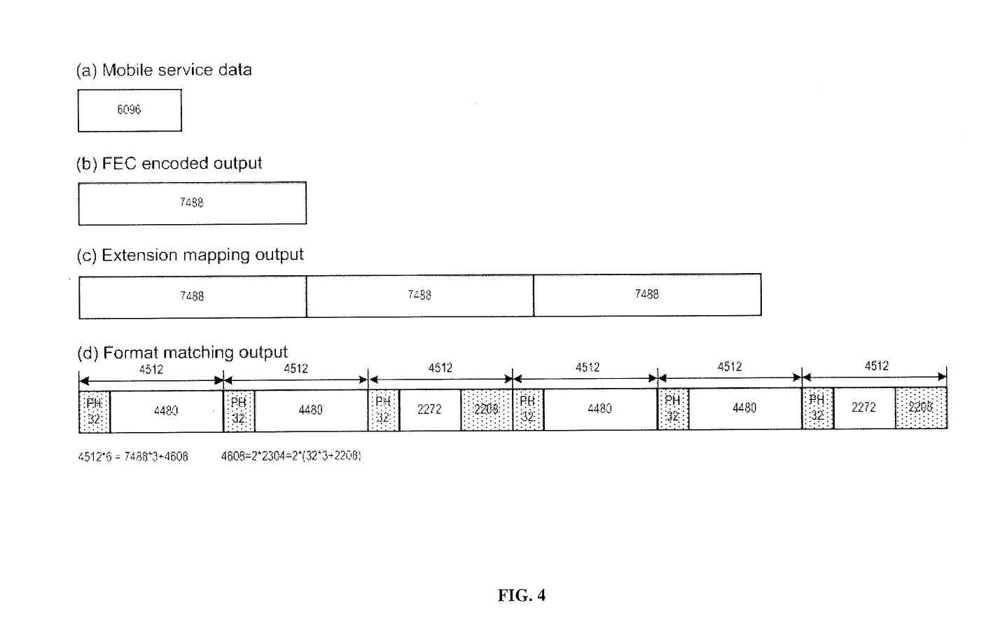

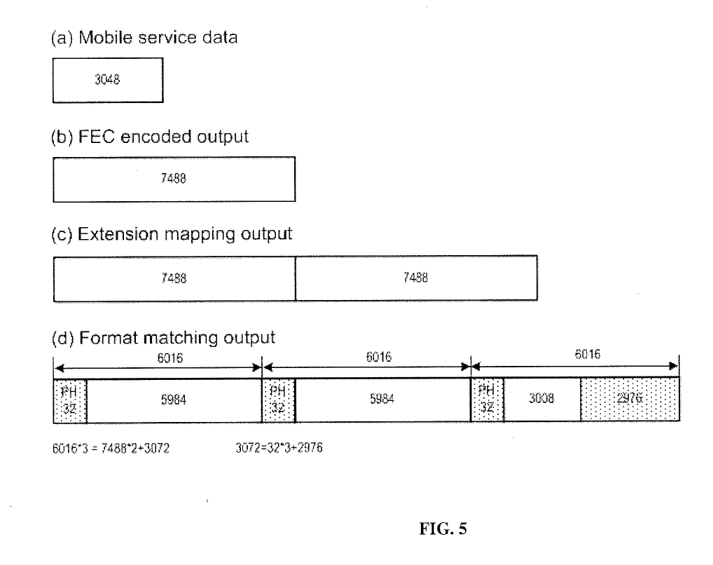

In format matching module 104, packet headers and matching bits are added to the mobile service data signal, making the length of the data frame compatible with DTMB standard since the format matched data frames will be encoded by a standard DTMB LDPC encoder. According to the DTMB standard, every LDPC data block (frame) needs at least one packet header to ensure that a conventional DTMB receiver can correctly select the terrestrial service data. Thus, for the example shown in FIG. 2, the format matching is shown in FIG. 4. Similarly, for the example shown in FIG. 3, the format matching is shown in FIG. 5.

Following format matching, the packet headers of the mobile service data signal are scrambled in module 105 prior to be sent to being multiplexed with the terrestrial service data. The packet headers are scrambled so that existing terrestrial receivers, which include a de-scrambler circuit, can recover the packet headers from the mobile service data signal. All of the mobile service data is not required to be scrambled; not scrambling all of the mobile service data reduces the complexity of the mobile receiver and lowers the power consumption of the mobile receiver since less descrambling is required in the receiver. It is noted that it is possible to scramble all of the mobile service data if a corresponding descrambler is provided in the mobile receiver.

After packet header scrambling, the mobile service data signal is sent to multiplexer 106 to be multiplexed with the terrestrial service data signal. In unit 107, a control frame is generated. Control frame generator 107 reads parameters from the DTMB transmitter such as the frame mode. In DTMB systems, the frame headers use pseudorandom-noise sequences in three different lengths: 420, 595, and 945 which are designated as PN420, PN595, and PN945, respectively. Every 225, 216, or 200 signal frames form a group called a super-frame for PN420, PN595, or PN945 mode, respectively. Thus the controller 107 knows how many signal frames form a super frame and controls the multiplexer such that the multiplexer correctly allocates positions to the mobile service frames (M_pos). The first signal frame of the super-frame is used as a control frame which, in the present invention, carries pre-defined mobile service parameters. These parameters are, for example, a special packet header for mobile service, the extension mapping type, the multiplexing mode (that is, the position of the mobile service-related signal frames in one super-frame), etc. An exemplary embodiment is depicted in the table below followed by a more detailed explanation.

| Syntax | No of bits | Description |
|---|---|---|
| M_PH | 32 | Special packet header for mobile service |
| M_rate | 2 | FEC encoding rate |
| M_mode | 2 | Extension mapping type |
| M_pos | 224 | Position of mobile service related signal frames |

M_PH, 32 bits
Packet header (32 bit) complies with ISO/IEC 13838-1 clause 2.4.3.2.
The packet ID (13 bit) in the packet header is set to be different
from any packet ID of the terrestrial service.
M_rate, 2 bits
00 for LDPC(7488, 3048) (CR = 0.4)
01 for LDPC(7488, 4572) (CR = 0.6)
10 for LDPC(7488, 6096) (CR = 0.8)
11 reserved
M_mode, 2 bits
00 for 4QAM(QPSK), 01 for 16QAM, 10 for 64QAM, 11 reserved
M_pos, 224 bits
There are N = 224/215/199 signal frames following each control frame
The most left N bits of the 224 bits indicate the position of mobile
service related signal frames. If the i-th bit among the N bits is 0, the
corresponding i-th signal frame is allocated for terrestrial service.
If it is 1, the corresponding signal frame is allocated for mobile service.

Following transmission of the multiplexed terrestrial service data and mobile service data signal, the signal is received by both terrestrial and mobile receivers. A conventional terrestrial receiver receives and decodes the multiplexed signal (both terrestrial service data and mobile service data) without any receiver modification. Such receivers are well known in the art and are commercially available and thus will not be described in detail here. Thus the present invention is completely compatible with existing terrestrial receivers. The terrestrial receiver merely selects the desired terrestrial service data on the basis of the packet header.

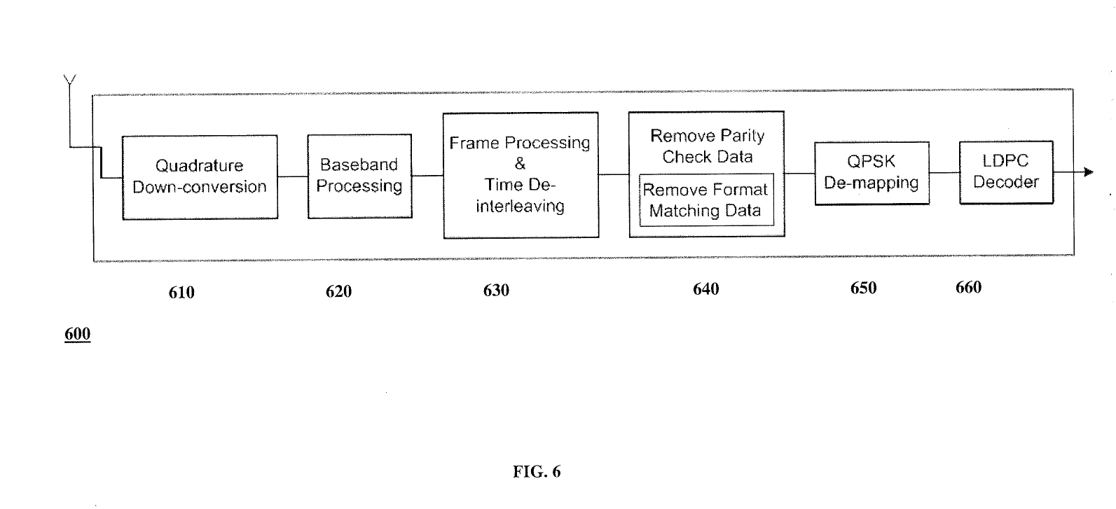

FIG. 6 depicts the architecture of a mobile receiver 600 used in the system of the present invention. Down-conversion, baseband processing, and frame processing occur at 610, 620, and 630, respectively, substantially similar to the terrestrial receiver. Time de-interleaving occurs at 630. The control frame is checked to determine whether data is mobile service data or terrestrial service data. At 640, the parity check data related to FEC coding from a standard DTMB transmitter is removed as well as the format matching data. Finally QPSK(4QAM) de-mapping and LDPC decoding occurs at 650 and 660 in the mobile receiver.

The payload rate of mobile and terrestrial service data is shown below for various modulation schemes and code rates:

| T-Service | | M-Service | | Payload Rate of |
|---|---|---|---|---|
| Code Rate | Modulation | Code Rate | Modulation | M-Service |
| CR0.6 | 64QAM | CR0.4 | QPSK | 0.61 Mbps |
| CR0.6 | 64QAM | CR0.6 | QPSK | 0.91 Mbps |
| CR0.6 | 64QAM | CR0.8 | QPSK | 1.22 Mbps |
| CR0.8 | 16QAM | CR0.4 | QPSK | 0.81 Mbps |
| CR0.8 | 16QAM | CR0.6 | QPSK | 1.22 Mbps |
| CR0.8 | 16QAM | CR0.8 | QPSK | 1.63 Mbps |
| CR0.6 | 64QAM | CR0.4 | 16QAM | 1.22 Mbps |
| CR0.6 | 64QAM | CR0.6 | 16QAM | 1.83 Mbps |
| CR0.6 | 64QAM | CR0.8 | 16QAM | 2.44 Mbps |

The present invention makes possible the implementation of new mobile services without any negative impact to existing terrestrial receivers and without the need for new and costly bandwidth. While the foregoing invention has been described in terms of the embodiments discussed above, numerous variations are possible. Accordingly, modifications and changes such as those suggested above, but not limited thereto, are considered to be within the scope of following claims.

What is claimed is:

1. A method for transmitting and receiving terrestrial and mobile services in one spectrum in a Digital Terrestrial Television Multimedia Broadcasting (DTMB) network, the method being compatible with reception by existing terrestrial DTMB receivers comprising:
providing terrestrial service data and mobile service data to be broadcast;
scrambling packet headers for the mobile service data;
scrambling the terrestrial service data;
multiplexing the terrestrial service data and mobile service data together to form multiplexed terrestrial service data and mobile service data;
receiving the multiplexed terrestrial service data and mobile service data at a terrestrial DTMB receiver;
separating the terrestrial service data from the mobile service data on the basis of packet headers; and
receiving the multiplexed terrestrial service data and mobile service data at a mobile DTMB receiver and using control frames to distinguish the terrestrial service data from the mobile service data.

2. The method as set forth in claim 1 further wherein the terrestrial service data is 64 QAM modulated and the mobile service data is QPSK modulated.

3. The method as set forth in claim 1 wherein the terrestrial service data is 16 QAM modulated and the mobile service data is QPSK modulated.

4. The method as set forth in claim 1 wherein remaining mobile service data other than the mobile service data packet headers is not scrambled.

5. A method for transmitting terrestrial and mobile services in one spectrum in a Digital Terrestrial Television Multimedia Broadcasting (DTMB) network compatible with existing terrestrial DTMB receivers comprising:
preparing terrestrial service data including scrambling the terrestrial service data;
encoding mobile service data;
performing extension mapping on encoded mobile service data;
adding packet headers and matching bits in the encoded mobile service data;
scrambling the packet headers for the encoded mobile service data, without scrambling remaining mobile service data;
multiplexing the scrambled terrestrial service data with the encoded mobile service data having scrambled packet headers;
transmitting a resultant multiplexed signal to a terrestrial and/or mobile receiving unit.

6. A mobile receiving unit for a Digital Terrestrial Television Multimedia Broadcasting (DTMB) network in which terrestrial service data is multiplexed with mobile service data comprising:
an antenna for receiving a multiplexed signal carrying both terrestrial service data and mobile service data;
a frame checking unit which checks a control frame and determines whether the data is terrestrial service data or mobile service data and distinguishes the terrestrial service data from the mobile service data on the basis of information in the control frame.

7. The mobile receiving unit for a Digital Terrestrial Television Multimedia Broadcasting (DTMB) network as set forth in claim 6 further comprising down-conversion, baseband processing, and frame processing units.

8. The mobile receiving unit for a Digital Terrestrial Television Multimedia Broadcasting (DTMB) network as set forth in claim 7 further comprising a parity check data removal unit and a de-mapping and decoding unit.

9. A Digital Terrestrial Television Multimedia Broadcasting (DTMB) terrestrial network comprising:
a transmitter that transmits a multiplexed signal, the multiplexed signal comprising terrestrial service data and mobile service data in a single spectrum, the terrestrial data being scrambled and the mobile service data having packet headers only scrambled, the multiplexed signal including control frames;
a terrestrial receiver receiving the multiplexed terrestrial service data and mobile service data, the terrestrial receiver being configured to select a terrestrial service data on the basis of decoded packet headers; and
a mobile receiver configured to receive the multiplexed signal and to distinguish a mobile service data on the basis of the control frames.

10. The Digital Terrestrial Television Multimedia Broadcasting (DTMB) terrestrial network according to claim 9 wherein the transmitter includes a scrambler for scrambling the terrestrial service data, an encoder for encoding the mobile service data, an extension mapper for mapping encoded mobile service data, a unit for adding packet headers and matching bits to the mobile service data, a unit for scrambling the packet headers of the mobile service data, and a multiplexer.

11. The Digital Terrestrial Television Multimedia Broadcasting (DTMB) terrestrial network as set forth in claim 9 wherein the terrestrial receivers are conventional DTMB terrestrial receivers such that the network is backwards compatible with existing terrestrial DTMB receivers.
